(19) United States
(12) Patent Application Publication
(10) Pub. No.: US 2025/0162684 A1
(43) Pub. Date: May 22, 2025

(54) BICYCLE POWER-SAVING CRANK

(71) Applicants: CHING-CHANG LO, Changhua City (TW); CHIN-CHU WANG, Taichung City (TW); TING-YUAN WANG, Taichung City (TW); LI-CHIEH LO, Changhua City (TW); TING-HUI WANG, Taichung City (TW); CHUNG-HSUAN LIN, Taichung City (TW)

(72) Inventors: CHING-CHANG LO, Changhua City (TW); CHIN-CHU WANG, Taichung City (TW); TING-YUAN WANG, Taichung City (TW); LI-CHIEH LO, Changhua City (TW); TING-HUI WANG, Taichung City (TW); CHUNG-HSUAN LIN, Taichung City (TW)

(21) Appl. No.: 19/008,673

(22) Filed: Jan. 3, 2025

Related U.S. Application Data
(63) Continuation-in-part of application No. 18/380,199, filed on Oct. 16, 2023.

(51) Int. Cl. B62M 1/36

(52) U.S. Cl. CPC B62M 1/36

(57) ABSTRACT

A bicycle power-saving crank includes: a base arm connected at one end to a chainwheel and rotatable synchronously with the chainwheel; a base sprocket, fixed to the base arm and facing in the chainwheel; an outer sprocket, rotatably connected to the other end of the base arm via an outer spindle; a transmission component, rotatably connected to the base sprocket and the outer sprocket; and an outer arm, rotatably connected to the outer spindle and a pedal and rotatable synchronously with the outer sprocket. When the base arm extends horizontally in the travel direction, while the axial extension line of the outer arm forms a 12° angle relative to the horizontal extension line of the base arm. This design ensures that, throughout the pedaling process, the outer arm consistently maintains an angle of 12° relative to the base arm, regardless of its rotational angle, thereby enhancing pedaling efficiency.

### BACKGROUND OF THE INVENTION

### Fields of the Invention

The present invention relates to a driving structure of a bicycle and, more particularly, to the combined structure of the crank.

### Descriptions of Related Art

The current bicycle driving, as shown in FIG. 1, involves a chainwheel rotatably connected to a frame via an axle, with a pair of cranks connected to the axle and the chainwheel in opposite directions, respectively. The ends of the cranks are connected to rotatable pedals. When pedaling a bicycle, force is exerted on the pedals and cranks by both feet, causing the cranks to rotate along a counterclockwise circular trajectory. This rotational movement of the cranks along the aforementioned path initiates the pivoting of the chainwheel, subsequently propelling the chain into rotation. The rotational motion of the chain impels the rear sprocket to revolve, ultimately leading to the rotation of the rear wheel and resulting in the forward motion of the bicycle.

In the absence of specialized cycling shoes designed for secure attachment to clipless pedals, the rotation of the cranks along their circular trajectory relies primarily on the downward force applied during pedaling. During the upstroke phase of pedaling, as the pedal is in an upward motion, effective force application becomes challenging. To increase operational efficiency, one solution is to wear cycling shoes with cleats capable of securely engaging with the pedals. However, the majority of the general public wears regular shoes when cycling and does not opt for clipless pedal system.

### SUMMARY OF THE INVENTION

The present invention provides a bicycle power-saving crank, comprising: a base arm, positioned on an outside of a chainwheel and connected at one end to the chainwheel, wherein the base arm is rotatable synchronously with the chainwheel; a base sprocket, fixed to the base arm and facing in the chainwheel; an outer sprocket, rotatably connected to the other end of the base arm via an outer spindle; a transmission component, rotatably connected to the base sprocket and the outer sprocket; and an outer arm, having one end rotatably connected to the outer spindle and rotatable synchronously with the outer sprocket and the other end rotatably connected to a pedal; wherein the outer arm is rotatably connected to the base arm and rotatable synchronously with the chainwheel along a circular base arm trajectory, while the pedal is rotatably connected to the outer arm and rotatable synchronously with the base arm along a circular outer arm trajectory that is offset outward in a travel direction relative to the base arm trajectory.

In the present invention, when the base arm extends horizontally in the travel direction of the bicycle, the axial extension line of the outer arm forms a 12° angle relative to the horizontal extension line of the base arm. This design ensures that, throughout the pedaling process, the outer arm consistently maintains an angle of 12° relative to the base arm, regardless of its rotational angle, thereby enhancing pedaling efficiency.

### BRIEF DESCRIPTION OF THE DRAWINGS

FIG. 1 is a side schematic view of the crank and the chainwheel of a conventional bicycle.

FIG. 2 is a side schematic view of the present invention, with the crank in a forward-extending position.

FIG. 3 is an operational schematic view of the present invention with the base arm in a downward-extending position.

FIG. 4 is an operational schematic view of the present invention with the base arm in a backward-extending position.

FIG. 5 is an operational schematic view of the present invention with the base arm in an upward-extending position.

FIG. 6 is a simulated operational schematic view of the base arm positions of FIGS. 2 to 5.

FIG. 7 is a schematic view showing the elevation angle of the outer arm relative to the base arm in the present invention.

FIG. 8 is a partially enlarged schematic view of FIG. 7.

FIG. 9 is a schematic view (I) showing the upward angle of the outer arm relative to the base arm and the trajectories of the base arm and the outer arm in the present invention.

FIG. 10 is a schematic view (II) showing the upward angle of the outer arm relative to the base arm and the trajectories of the base arm and the outer arm in the present invention.

FIG. 11 is a simulated schematic view showing the power-saving frame for implementation of the present invention compared to a standard frame.

FIG. 12 is a schematic view showing the assembly mechanism of the base arm and the outer arm in the present invention.

### DETAILED DESCRIPTION OF THE PREFERRED EMBODIMENT

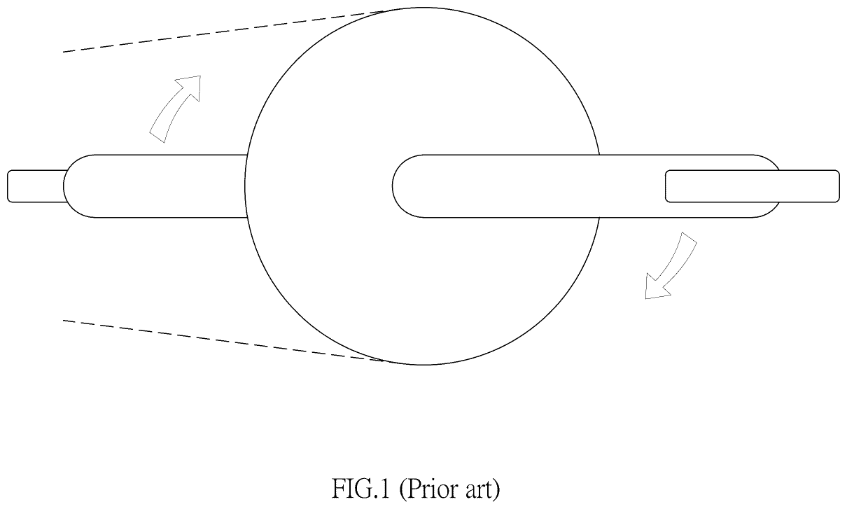

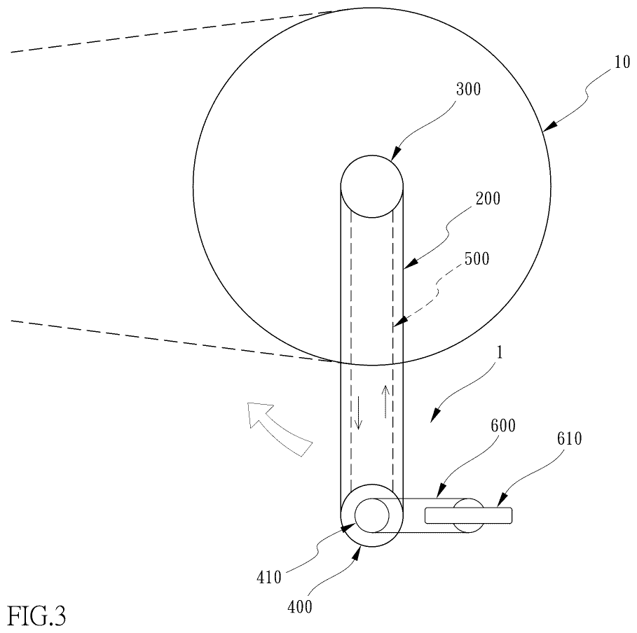

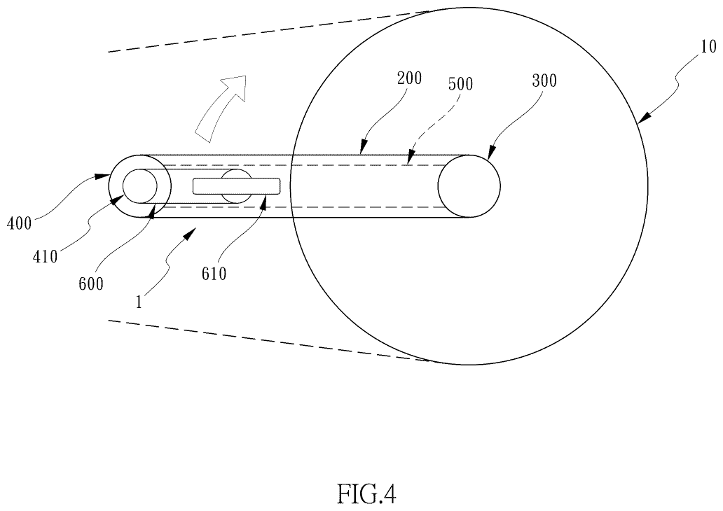

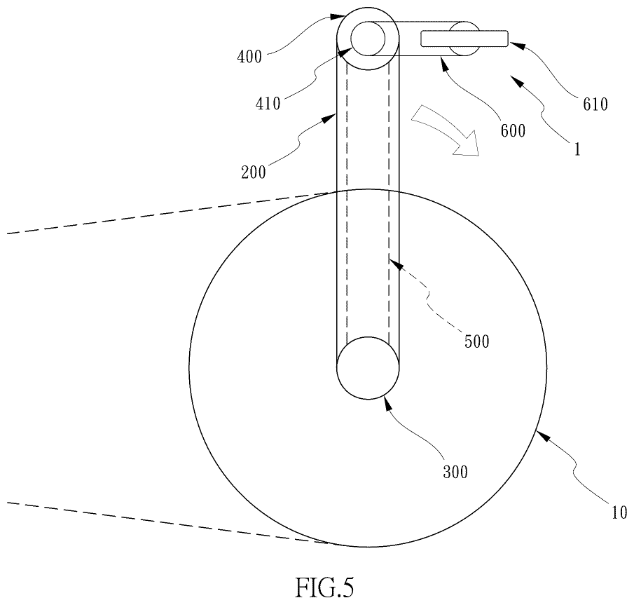

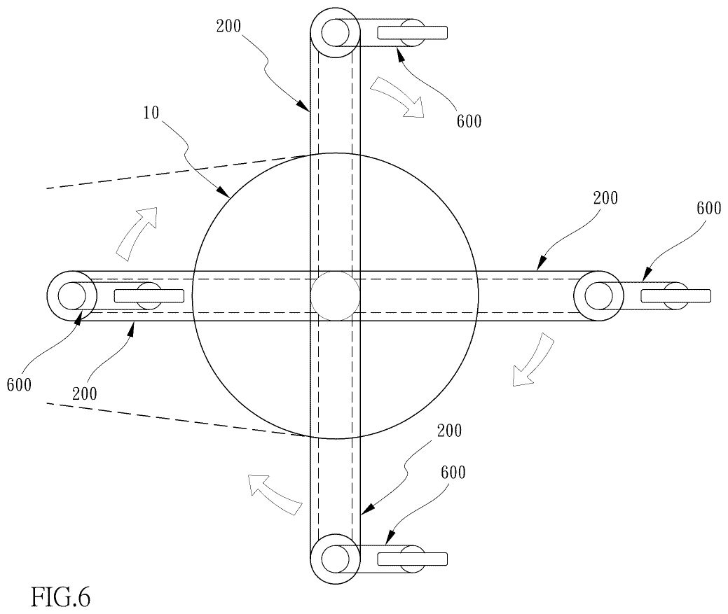

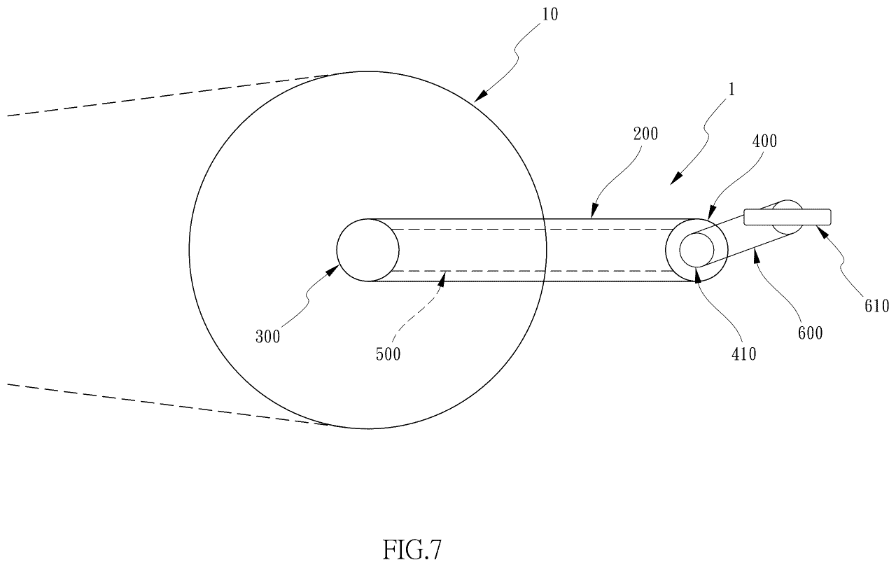

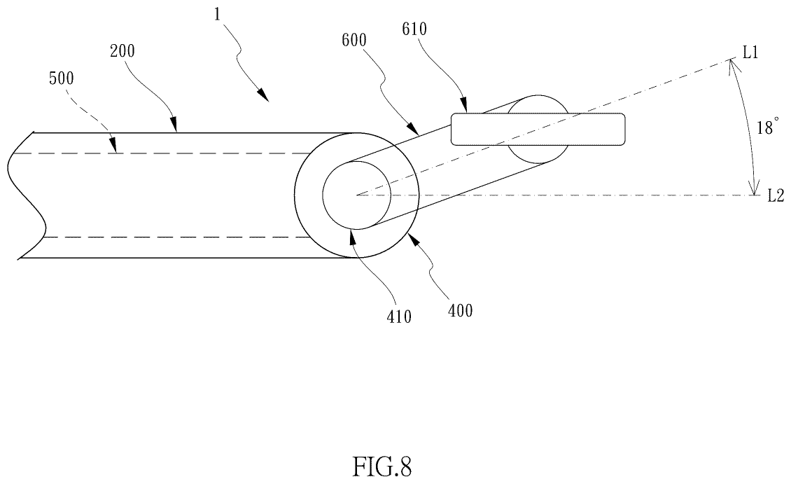

Please refer to FIGS. 1 to 12, which illustrate a bicycle power-saving crank 1 of the present invention, including:
a base arm 200, positioned on the outside of a chainwheel 10 and connected at one end to the chainwheel 10, wherein the base arm 200 can rotate synchronously with the chainwheel 10;
a base sprocket 300, fixed to the base arm 200 and facing in the chainwheel 10;
an outer sprocket 400, rotatably connected to the other end of the base arm 200 via an outer spindle 410;
a transmission component 500, rotatably connected to the base sprocket 300 and the outer sprocket 400; and
an outer arm 600, having one end rotatably connected to the outer spindle 410 and configured to rotate synchronously with the outer sprocket 400 and the other end rotatably connected to a pedal 610.

In this embodiment, the transmission component 500 can be a chain or gear. The transmission component 500 wraps around both the base sprocket 300 and the outer sprocket 400. The gear may be a bevel gear which can facilitate shifting and power transmission. With the transmission component 500 operating in conjunction with the base sprocket 300 and the outer sprocket 400, the rotational position of the outer arm 600 relative to the base arm 200 can be effectively controlled. For instance, the rotatable connection point of the outer arm 600 with the base arm 200 can be controlled to rotate synchronously with the chainwheel 10 along a circular base arm trajectory T1. The pedal 610 is rotatably connected to the outer arm 600 and can rotate synchronously with the base arm 200 along a circular outer arm trajectory T2. Because the outer arm trajectory is offset outward in the travel direction compared to the base arm trajectory, the original dead spot position (where applying downward force vertically is ineffective for transmitting pedaling force) shifts forward. Here, “forward” refers to the travel direction of the bicycle, with the right side of the figure used as an example. This adjustment enables more effective force transmission, resulting in energy savings and improved pedaling performance.

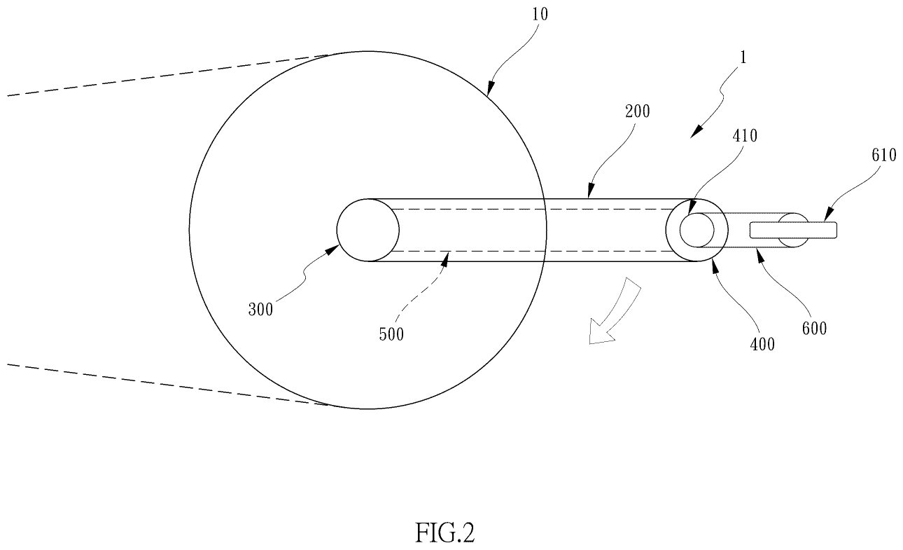

Additionally, when the base arm 200 is horizontally extended in the travel direction of bicycle, the outer arm 600 extends in the same direction as the base arm 200, as shown in FIG. 2. This refers to the combined length of the base arm 200 and the outer arm 600 when both are in a horizontal state, representing the longest lever arm of the bicycle power-saving crank 1. For instance, the base arm 200 has a length approximately the same as that of the currently known crank (e.g., 170 mm). Through the addition of the outer arm 600, an additional length (approximately 85 mm) results in an increased lever arm length (the total length of the base arm and outer arm axes is 255 mm). This is equivalent to increasing the original lever arm length by half.

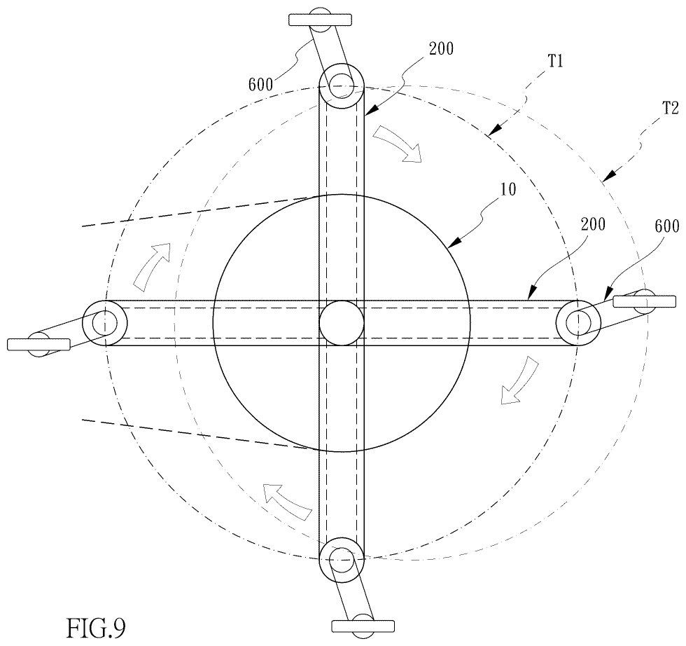

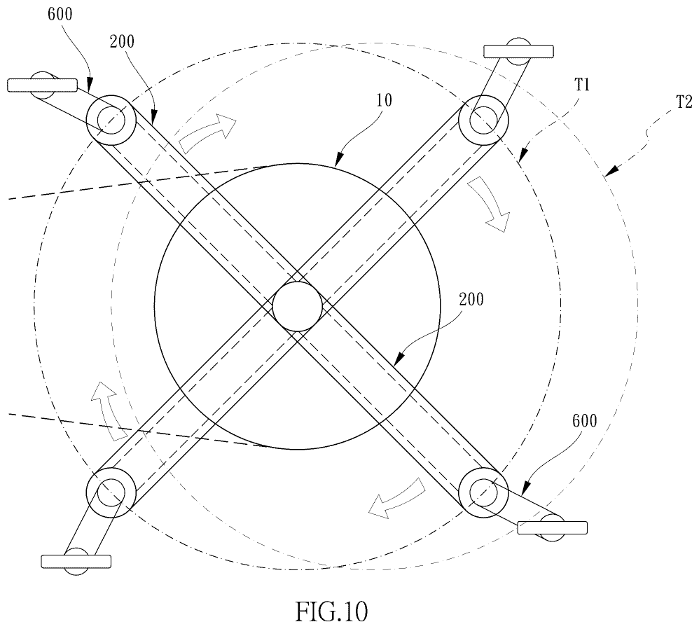

It is particularly worth mentioning that, referring to FIGS. 9 and 10, the base arm trajectory T1 and the outer arm trajectory T2 have the same diameter and intersect twice. The shortest distance between the outer arm trajectory T2 and the chainwheel 10 is less than the smallest distance between the base arm trajectory T1 and the chainwheel 10. Additionally, when the base arm 200 is horizontally extended in the travel direction of bicycle, and the axial extension line L1 of the outer arm 600 forms an included angle of 12° to 36° relative to the horizontal extension line L2 of the base arm 200. The design ensures that, throughout the pedaling process, the outer arm 600 consistently maintains an angle of 12° relative to the base arm 200, regardless of its rotational angle. As such, this not only allows the outer arm 600 to retract unnecessary extensions in the rearward direction, but also enables more efficient execution of the pedaling motion.

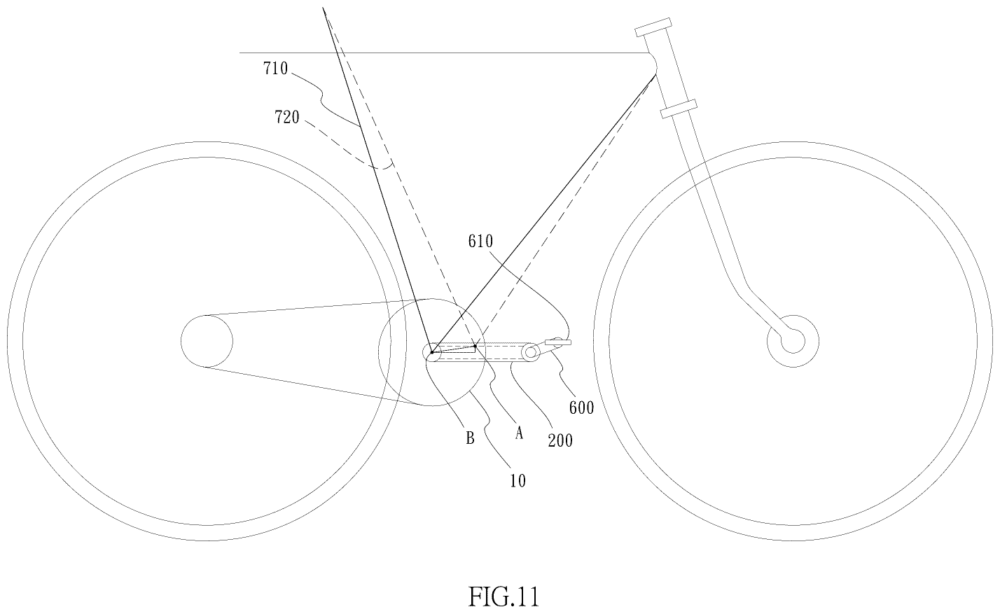

Accordingly, referring to FIG. 11, when the bicycle power-saving crank 1 of the present invention is applied to the bicycle frame, the bicycle frame is adapted to the power-saving crank 1 and is referred to herein as the power-saving frame 710. In this context, the position where the crank is installed to the frame, i.e. the center of the main spindle tube (commonly known as the bottom bracket), is set to shift backward and downward relative to a standard frame 720. In the illustration, the point A represents the center where the chainwheel is mounted on the standard frame 720, while the point B represents the center where the chainwheel 10 is mounted on the power-saving frame 710. The length of the outer arm 600 (i.e. the distance between the outer spindle 410 and the pedal 610) is denoted as Y The base arm 200 is horizontally extended in the direction of bicycle travel, and the elevation angle of the outer arm 600 relative to the base arm 200 is denoted as θ. As a result, the rearward displacement value of the central position of the main spindle tube in the power-saving frame 710 is calculated as B=A−Y cos θ, and the downward displacement value of the central position of the main spindle tube in the power-saving frame 710 is calculated as B=A−Y sin θ.

To further illustration, the seat tube of the bicycle has a top end equipped with a saddle and a bottom end fixed to the bottom bracket. The seat tube is set at an inclined angle, designed ergonomically at 12°. However, the 12° angle is not an absolute value but rather an average, with the angle slightly adjusted depending on the intended use. For instance, for racing bicycles, riders often lower their bodies to reduce air resistance. In this case, the angle between the outer arm 600 and the base arm 200 will decrease by about 2-3°. Conversely, for leisure bicycles, the rider's body can be kept upright, which increases the angle between the outer arm 600 and the base arm 200. However, the 12° angle remains the most suitable for the majority of cases.

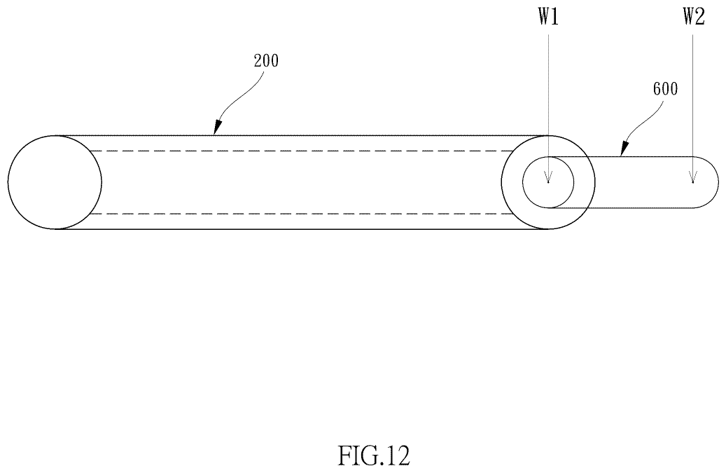

Referring to FIG. 12, when the base arm 200 is not assembled with the outer arm 600, the length of the base arm 200 is 170 mm, and W1 is 18 kg. In this case, the pedaling force is measured as 170 mm×18 kg=3060. When the base arm 200 is fitted with the outer arm 600, the length of the base arm 200 is 170 mm, and the outer arm 600 is 85 mm long. W2 is X kg, calculated based on the principle of inverse proportionality in physical laws. Given that the total length of the base arm 200 and the outer arm 600 is 170 mm+85 mm=255 mm, the measured pedaling force X is 12 kg (i.e., W2 is 12 kg) according to the equation: 255×X=170×18 kg (3060). As such, when the outer arm 600 is installed relative to the base arm 200 at an upward angle of 12°, W2 is 12 kg, which is approximately 50% less than W1, which is 18 kg. This demonstrates that when the outer arm 600 is positioned at a 12° upward angle relative to the base arm 200, a more efficient pedaling motion is indeed achieved.

It should be noted that the present invention combines the base arm 200 and the outer arm 600 to form a crank. In principle, a bicycle is driven by a pair of cranks in opposite positions to rotate the chainwheel 10. However, for clarity in identifying component positions and operation, only a single crank is depicted in the figures, and the installation of the bicycle power-saving crank 1 on the bicycle frame is not shown.

What is claimed is:

1. A bicycle power-saving crank, comprising:
a base arm, positioned on an outside of a chainwheel and connected at one end to the chainwheel, wherein the base arm is rotatable synchronously with the chainwheel;
a base sprocket, fixed to the base arm and facing in the chainwheel;
an outer sprocket, rotatably connected to the other end of the base arm via an outer spindle;
a transmission component, rotatably connected to the base sprocket and the outer sprocket; and
an outer arm, having one end rotatably connected to the outer spindle and rotatable synchronously with the outer sprocket and the other end rotatably connected to a pedal;
wherein the outer arm is rotatably connected to the base arm and rotatable synchronously with the chainwheel along a circular base arm trajectory, while the pedal is rotatably connected to the outer arm and rotatable synchronously with the base arm along a circular outer arm trajectory that is offset outward in a travel direction relative to the base arm trajectory; and
wherein when the base arm extends horizontally in the travel direction, an axial extension line of the outer arm forms a 12° angle relative to a horizontal extension line of the base arm, whereby throughout a pedaling process, the outer arm consistently maintains an angle of 12° relative to the base arm, regardless of a rotational angle of the outer arm, thereby enhancing pedaling efficiency.

2. The bicycle power-saving crank as claimed in claim 1, wherein transmission component is a chain or gear.

3. The bicycle power-saving crank as claimed in claim 1, wherein when the base arm is horizontally extended in the travel direction, the outer arm extends in the same direction as the base arm.

4. The bicycle power-saving crank as claimed in claim 1, wherein the base arm trajectory and the outer arm trajectory have the same diameter and intersect twice.

5. The bicycle power-saving crank as claimed in claim 1, wherein a shortest distance between the outer arm trajectory and the chainwheel is less than a smallest distance between the base arm trajectory and the chainwheel.

6. The bicycle power-saving crank as claimed in claim 1, wherein an axial dimension of the base arm is greater than that of the outer arm.
